(19) United States
(12) Patent Application Publication
(10) Pub. No.: US 2018/0243698 A1
(43) Pub. Date: Aug. 30, 2018

(54) FILTER UNIT

(71) Applicant: SUMITOMO ELECTRIC INDUSTRIES, LTD., Osaka-shi, Osaka (JP)

(72) Inventors: Hiromu TANAKA, Sennan-gun, Osaka (JP); Tomoyuki YONEDA, Sennan-gun, Osaka (JP); Hiroko MIKI, Sennan-gun, Osaka (JP); Toru MORITA, Sennan-gun, Osaka (JP)

(73) Assignee: SUMITOMO ELECTRIC INDUSTRIES, LTD., Osaka-shi, Osaka (JP)

(21) Appl. No.: 15/758,105

(22) PCT Filed: Jun. 13, 2016
(86) PCT No.: PCT/JP2016/067506

§ 371 Date: Mar. 7, 2018

(30) Foreign Application Priority Data
Oct. 8, 2015 (JP) 2015-200609

(51) Int. Cl. B01D 63/04; B01D 65/02

(52) U.S. Cl. CPC B01D 63/04; B01D 2319/04; B01D 2321/185; B01D 65/02

(57) ABSTRACT

A filter unit according to the present invention includes a plurality of filtration modules and a plurality of air bubble generation modules. Each filtration module includes a plurality of hollow fiber membranes extending in an up-down direction and arranged side by side in a curtain shape and a pair of holding members to which top and bottom ends of the hollow fiber membranes are fixed. The air bubble generation modules discharge bubbles toward the hollow fiber membranes. The filtration modules are arranged in parallel at intervals. each air bubble generation module has a discharge port that is disposed between lower holding members of a pair of adjacent filtration modules and above bottom ends of the lower holding members.

### TECHNICAL FIELD

The present invention relates to a filter unit.

The present application claims priority based on Japanese Patent Application No. 2015-200609 filed on Oct. 8, 2015, the entire contents of which are incorporated herein.

### BACKGROUND ART

Filter units including filtration modules, in which a plurality of hollow fiber membranes extending in an up-down direction and arranged side by side are fixed to a pair of holding members at the top and bottom ends thereof, are used as solid-liquid separation treatment apparatuses in sewage treatment and manufacturing processes of pharmaceuticals etc. Such a filter unit is immersed in untreated liquid when used, and performs a filtration process by blocking impurities contained in the untreated liquid at the surfaces of the hollow fiber membranes and allowing components other than the impurities to permeate into the inside of the hollow fiber membranes.

However, since the filter unit blocks the impurities contained in the untreated liquid at the surfaces of the hollow fiber membranes, the impurities that have not permeated into the inside of the hollow fiber membranes may adhere to the surfaces of the hollow fiber membranes. Therefore, the above-described filter unit has a risk that the filtration efficiency for the liquid to be filtered will be reduced due to the impurities that have adhered to the surfaces of the hollow fiber membranes.

A structure that is currently used to solve the above-described problem discharges bubbles toward the hollow fiber membranes that constitute the filtration modules to remove the impurities that have adhered to the surfaces of the hollow fiber membranes with the bubbles. A filter unit having such a structure is proposed in, for example, “Multilayered Porous Hollow Fiber, Hollow Fiber Membrane Module, and Filtration Apparatus” (Japanese Unexamined Patent Application Publication No. 2011-31122).

The filter unit described in the above-described publication includes diffuser tubes (air supply tubes) disposed below the filtration modules. In this filter unit, a diffusing blower supplies pressurized air to the diffuser tubes so that the air can be jetted from diffusion holes (gas jetting holes) formed in the diffuser tubes. In this filter unit, the air jetted from the diffusion holes removes the impurities by abrading the surfaces of the hollow fiber membranes and causing titubation of the hollow fiber membranes.

### CITATION LIST

### Patent Literature

PTL 1: Japanese Unexamined Patent Application Publication No. 2011-31122

### SUMMARY OF INVENTION

### Technical Problem

However, according to the filtration modules described in the above publication, part of the air jetted from the diffuser tubes comes into contact with the bottom surfaces of lower holding members to which the bottom ends of the hollow fiber membranes are fixed. Thus, it is difficult to directly supply the air jetted from the diffuser tubes to the hollow fiber membranes of the filtration modules. Therefore, there is a risk that the surfaces of the hollow fiber membranes of the filtration modules cannot be sufficiently cleaned or the cleaning cost will be increased due to an increase in the amount of air to be supplied.

The present invention has been made in light of the above-described circumstances, and its object is to provide a filter unit in which the surfaces of hollow fiber membranes can be effectively cleaned.

### Solution to Problem

A filter unit according to an aspect of the present invention made to achieve the above-described object includes a plurality of filtration modules and a plurality of air bubble generation modules. Each filtration module includes a plurality of hollow fiber membranes extending in an up-down direction and arranged side by side in a curtain shape and a pair of holding members to which top and bottom ends of the hollow fiber membranes are fixed. The air bubble generation modules discharge bubbles toward the hollow fiber membranes. The filtration modules are arranged in parallel at intervals. Each air bubble generation module has a discharge port that is disposed between lower holding members of a pair of adjacent filtration modules and above bottom ends of the lower holding members.

### Advantageous Effects of Invention

According to the filter unit of the present invention, the surfaces of the hollow fiber membranes can be effectively cleaned.

### BRIEF DESCRIPTION OF DRAWINGS

FIG. 1 is a schematic side view of a filter unit according to an embodiment of the present invention.

FIG. 2 is a schematic perspective view of an air bubble generation module included in the filter unit illustrated in FIG. 1.

FIG. 3 is a schematic plan view of the air bubble generation module illustrated in FIG. 2.

FIG. 4 is a sectional view of the air bubble generation module illustrated in FIG. 3 taken along line A-A.

FIG. 5 is a sectional view of the air bubble generation module illustrated in FIG. 3 taken along line B-B.

FIG. 6 is a schematic side view illustrating the arrangement of lower holding members and an air bubble generation module in the filter unit illustrated in FIG. 1.

Reference Signs List

1 filtration module 2 air bubble generation module 3 frame
4 diffuser tube 5 discharge mechanism 11 hollow fiber membrane
12 upper holding member 12a drain nozzle
13 lower holding member 21 discharge port 22 base portion
23 projecting portion 23a front wall 23b rear wall
24, 30a, 30b, 31a, 31b opening
25 gas introducing chamber 26a first gas inducing chamber 26b
second gas inducing chamber
27 gas discharging chamber 28, 29a, 29b partitioning wall
32 round bar 51 collecting pipe 52 suction pump

### DESCRIPTION OF EMBODIMENTS

### Description of Embodiments of Present Invention

Embodiments of the present invention will be described first.

A filter unit according to an aspect of the present invention includes a plurality of filtration modules and a plurality of air bubble generation modules. Each filtration module includes a plurality of hollow fiber membranes extending in an up-down direction and arranged side by side in a curtain shape and a pair of holding members to which top and bottom ends of the hollow fiber membranes are fixed. The air bubble generation modules discharge bubbles toward the hollow fiber membranes. The filtration modules are arranged in parallel at intervals. Each air bubble generation module has a discharge port that is disposed between lower holding members of a pair of adjacent filtration modules and above bottom ends of the lower holding members.

Since each air bubble generation module of the filter unit has the discharge port that is disposed between the lower holding members of the pair of adjacent filtration modules and above the bottom ends of the lower holding members, the bubbles discharged from the discharge port can be directly supplied to the hollow fiber membranes without being blocked by the bottom surfaces of the lower holding members. Thus, in the filter unit, the surfaces of the hollow fiber membranes can be effectively cleaned.

The discharge port of each air bubble generation module is preferably at a horizontal level close to a horizontal level of the top ends of the lower holding members of the pair of adjacent filtration modules. When the discharge port of each air bubble generation module is at a horizontal level close to a horizontal level of the top ends of the lower holding members of the pair of adjacent filtration modules, the bubbles discharged from the discharge port can be supplied to the hollow fiber membranes without causing the bubbles to come into contact with the side surfaces of the lower holding members. Therefore, portions of the hollow fiber membranes around the bottom ends of the hollow fiber membranes can be easily cleaned. In addition, according to this configuration, the distance over which the surfaces of the hollow fiber membranes are abraded by the bubbles discharged from the discharge port can be increased. Accordingly, the cleaning effect provided by the bubbles can be further enhanced.

The discharge port of each air bubble generation module is preferably formed in an oblong shape whose longitudinal direction is a direction parallel to the filtration modules. When the discharge port of each air bubble generation module has an oblong shape whose longitudinal direction is a direction parallel to the filtration modules, the diameter of the bubbles can be increased relative to the gap between the pair of adjacent lower holding members. As a result, the surfaces of the hollow fiber membranes can be more efficiently cleaned.

Each air bubble generation module is preferably configured to discharge the bubbles intermittently. When each air bubble generation module is configured to discharge the bubbles intermittently, relatively large bubbles can be discharged. Therefore, the energy of the individual bubbles can be increased and the surfaces of the hollow fiber membranes can be more effectively cleaned.

Each air bubble generation module preferably has gaps between the air bubble generation module and side surfaces of the lower holding members of the pair of adjacent filtration modules. When each air bubble generation module has gaps between the air bubble generation module and the side surfaces of the lower holding members of the pair of adjacent filtration modules, the upward pressure applied to the bubbles discharged from the discharge port can be increased by using the upward flow of the untreated liquid that is present between the air bubble generation module and the side surfaces of the lower holding members of the pair of adjacent filtration modules. Accordingly, the cleaning effect provided by the bubbles discharged from the discharge port can be further enhanced.

Each air bubble generation module is preferably spaced from the lower holding members of the pair of adjacent filtration modules. When each air bubble generation module is spaced from the lower holding members of the pair of adjacent filtration modules, the upward flow of the untreated liquid can be easily generated between the air bubble generation module and the lower holding members of the pair of adjacent filtration modules. Accordingly, the upward pressure applied to the bubbles discharged from the discharge port can be easily and reliably increased by using the upward flow of the untreated liquid, and the cleaning effect can be further enhanced.

In this specification, “up” means “up” relative to the filter unit according to the present invention in a used state (state in which the filter unit is immersed in the untreated liquid), and “down” is the opposite of “up”. The phrase “hollow fiber membranes are arranged in a curtain shape” means that the region in which the hollow fiber membranes are present has a long axis in a cross section perpendicular to the up-down direction. The phrase “filtration modules are arranged in parallel” means that the filtration modules are arranged so that the long axes of the regions in which the hollow fiber membranes are present are parallel to each other. Here, the phrase “axes are parallel” means that the angles between the axes are in the range of 0°±10°, more preferably 0°±5°, and still more preferably 0°±3°. The “horizontal level close to a horizontal level of top ends of the lower holding members” is a horizontal level that is spaced from the horizontal level of the top ends of the lower holding members by less than or equal to 5 mm, and more preferably less than or equal to 2 mm, in the vertical direction (upward or downward).

### DETAILED DESCRIPTION OF EMBODIMENT OF PRESENT INVENTION

A filter unit according to an embodiment of the present invention will now be described with reference to the drawings.

### [Filter Unit]

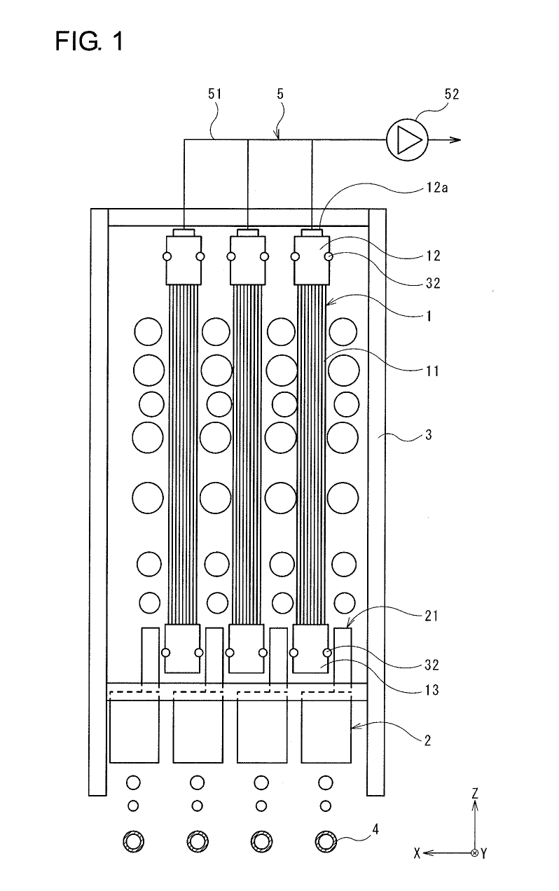

A filter unit illustrated in FIG. 1 includes a plurality of filtration modules 1 and a plurality of air bubble generation modules 2. Each filtration module 1 includes a plurality of hollow fiber membranes 11 extending in an up-down direction and arranged side by side in a curtain shape, an upper holding member 12 to which the top ends of the hollow fiber membranes 11 are fixed, and a lower holding member 13 to which the bottom ends of the hollow fiber membranes 11 are fixed. The air bubble generation modules 2 discharge bubbles toward the hollow fiber membranes 11. The filter unit illustrated in FIG. 1 also includes a frame 3 that holds the filtration modules 1 and the air bubble generation modules 2, a plurality of diffuser tubes 4 that supply gas to the air bubble generation modules 2, and a discharge mechanism 5 that discharges treated liquid that has been filtered by the filtration modules 1. Each of the upper holding members 12 and the lower holding members 13 is rod-shaped. In each filtration module 1, the longitudinal direction of the upper holding member 12 and the lower holding member 13 is parallel to the long axis of the region in which the hollow fiber membranes 11 are present in a cross section perpendicular to the up-down direction. Thus, each filtration module 1 is plate-shaped. In the following description, the longitudinal direction of the upper holding member 12 and the lower holding member 13 is referred to also as a Y direction, an opposing direction in which the upper holding member 12 and the lower holding member 13 oppose each other (up-down direction) is referred to also as a Z direction, and a transverse direction of the upper holding member 12 and the lower holding member 13 that is perpendicular to the longitudinal direction and the opposing direction is referred to also as an X direction.

The filter unit is immersed in untreated liquid when used. The filter unit performs a filtration process by preventing impurities contained in the untreated liquid from permeating into the inside of the hollow fiber membranes 11 and allowing components other than the impurities to permeate into the hollow fiber membranes 11.

The filtration modules 1 included in the filter unit are arranged in parallel at intervals. Each air bubble generation module 2 of the filter unit has a discharge port 21 that is disposed between the lower holding members 13 of a pair of adjacent filtration modules 1 and above the bottom ends of the lower holding members 13.

Since each air bubble generation module 2 of the filter unit has the discharge port 21 that is disposed between the lower holding members 13 of the pair of adjacent filtration modules 1 and above the bottom ends of the lower holding members 13, the bubbles discharged from the discharge port 21 can be directly supplied to the hollow fiber membranes 11 without being blocked by the bottom surfaces of the lower holding members 13. Thus, in the filter unit, the surfaces of the hollow fiber membranes 11 can be effectively cleaned.

### (Air Bubble Generation Modules)

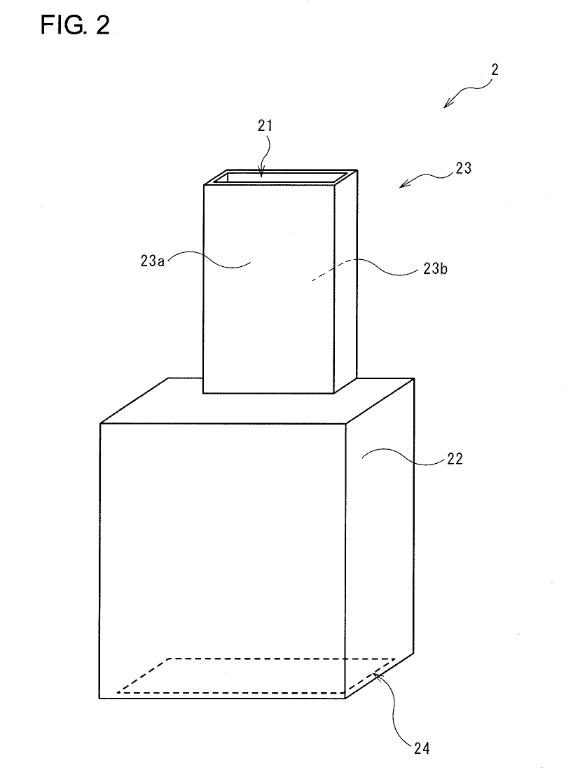

As illustrated in FIG. 2, each air bubble generation module 2 includes a base portion 22 and a projecting portion 23 that projects upward (Z direction in FIG. 1) from the base portion 22. The projecting portion 23 includes a front wall 23a and a rear wall 23b that oppose each other, and the rear surface thereof (outer surface of the rear wall 23b) is flush with the rear surface of the base portion 22. The air bubble generation module 2 has an opening 24 at the bottom of the base portion 22. The air bubble generation module 2 has a discharge port 21 at the top end of the projecting portion 23. The air bubble generation module 2 is configured so as to be capable of receiving the gas discharged from a corresponding diffuser tube 4 through the opening 24 and discharging the gas upward from the discharge port 21. Here, the “front” of the air bubble generation module 2 means the left in the X direction in FIG. 1, and the “rear” of the air bubble generation module 2 means the right in the X direction. In addition, the “left” of the air bubble generation module 2 means the left in the Y direction when the left in the X direction is the front, and the “right” of the air bubble generation module 2 means the right in the Y direction when the left in the X direction is the front. These directions are defined for convenience, and do not limit the configuration of the air bubble generation module 2.

The configuration of the air bubble generation module 2 is not particularly limited as long as the gas introduced through the base portion 22 can be discharged from the discharge port 21, and may be such that the gas introduced through the base portion 22 is continuously discharged from the discharge port 21. However, the air bubble generation module 2 is preferably configured so as to be capable of intermittently discharging the bubbles. When each air bubble generation module 2 of the filter unit is configured so as to be capable of intermittently discharging the bubbles, relatively large bubbles can be discharged from the discharge port 21. Therefore, in the filter unit, the energy of the individual bubbles can be increased and the surfaces of the hollow fiber membranes 11 can be more effectively cleaned.

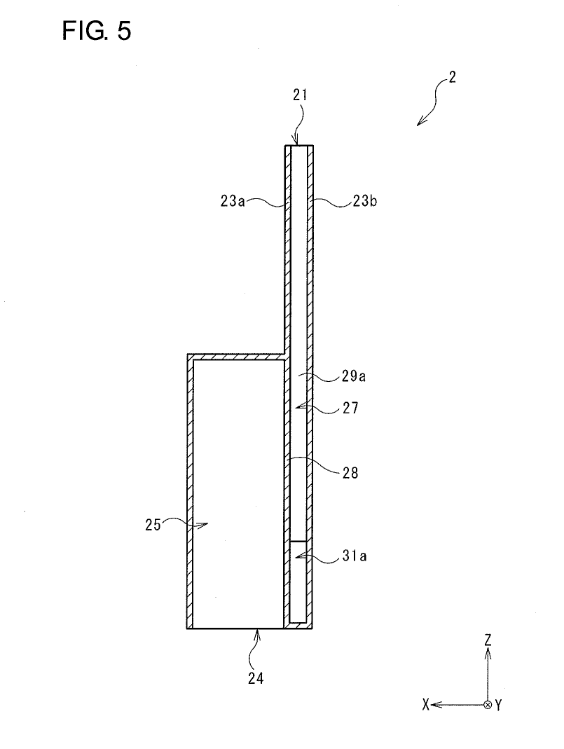

An example of an air bubble generation module 2 configured so as to be capable of intermittently discharging the bubbles will be described with reference to FIGS. 2 to 5. The external size of the air bubble generation module 2, such as the size of the discharge port 21, described below may be the same as that in the case where the air bubble generation module 2 is configured to discharge the bubbles continuously. The configuration described below is an example, and the air bubble generation module 2 configured so as to be capable of intermittently discharging the bubbles may have a configuration different from that described below.

The air bubble generation module 2 includes a gas introducing chamber 25, a first gas inducing chamber 26a, a second gas inducing chamber 26b, and a gas discharging chamber 27. The air bubble generation module 2 has the opening 24 at the bottom end of the gas introducing chamber 25. The air bubble generation module 2 has the discharge port 21 at the top end of the gas discharging chamber 27.

The gas introducing chamber 25 is formed in a rectangular parallelepiped shape in the base portion 22. The gas introducing chamber 25 is partitioned from the first gas inducing chamber 26a, the second gas inducing chamber 26b, and the gas discharging chamber 27 by a partitioning wall 28. The partitioning wall 28 extends downward continuously from the bottom end of the front wall 23a of the projecting portion 23. A portion of the partitioning wall 28 by which the gas introducing chamber 25 is partitioned from the first gas inducing chamber 26a has an opening 30a at the top end thereof. A portion of the partitioning wall 28 by which the gas introducing chamber 25 is partitioned from the second gas inducing chamber 26b has an opening 30b at the top end thereof. Thus, the gas introducing chamber 25 and the first gas inducing chamber 26a communicate through the opening 30a, and the gas introducing chamber 25 and the second gas inducing chamber 26b communicate through the opening 30b.

The first gas inducing chamber 26a and the second gas inducing chamber 26b are each formed in a rectangular parallelepiped shape in the base portion 22. The first gas inducing chamber 26a is on the left side (left side in the Y direction) of the projecting portion 23 in plan view, and the second gas inducing chamber 26b is on the right side (right side in the Y direction) of the projecting portion 23 in plan view. The first gas inducing chamber 26a is partitioned from the gas introducing chamber 25 by the partitioning wall 28, and is partitioned from the gas discharging chamber 27 by a partitioning wall 29a. The second gas inducing chamber 26b is partitioned from the gas introducing chamber 25 by the partitioning wall 28, and is partitioned from the gas discharging chamber 27 by a partitioning wall 29b. The partitioning wall 29a, by which the first gas inducing chamber 26a is partitioned from the gas discharging chamber 27, has an opening 31a at the bottom end thereof. The partitioning wall 29b, by which the second gas inducing chamber 26b is partitioned from the gas discharging chamber 27, has an opening 31b at the bottom end thereof. Accordingly, the first gas inducing chamber 26a and the gas discharging chamber 27 communicate through the opening 31a, and the second gas inducing chamber 26b and the gas discharging chamber 27 communicate through the opening 31b.

The gas discharging chamber 27 is formed in a rectangular parallelepiped shape in the base portion 22 and the projecting portion 23. The gas discharging chamber 27 is partitioned from the gas introducing chamber 25 by the partitioning wall 28, from the first gas inducing chamber 26a by the partitioning wall 29a, and from the second gas inducing chamber 26b by the partitioning wall 29b.

Since the gas generation module 2 is configured as described above, the gas introduced into the gas introducing chamber 25 first flows to an upper section of the gas introducing chamber 25. The gas that has reached the upper section is introduced into the first gas inducing chamber 26a through the opening 30a and into the second gas inducing chamber 26b through the opening 30b. As a result, the gas introduced into the gas introducing chamber 25 accumulates in the regions around the top ends of the gas introducing chamber 25, the first gas inducing chamber 26a, and the second gas inducing chamber 26b. Then, when more gas is introduced into the gas introducing chamber 25, the interface between the gas and liquid is divided into components in the gas introducing chamber 25, the first gas inducing chamber 26a, and the second gas inducing chamber 26b, and the components of the interface move downward while being at substantially equal horizontal levels. When the amount of gas in the first gas inducing chamber 26a and the second gas inducing chamber 26b exceeds a certain amount, the gas is introduced into the gas discharging chamber 27 through the opening 31a and the opening 31b, and relatively large bubbles are intermittently discharged from the discharge port 21. In the present embodiment, a pair of gas inducing chambers are disposed on the left and right sides of the projecting portion 23 in plan view. Alternatively, however, a single gas inducing chamber may be provided only on the left or right side of the projecting portion 23, or at the center of the projecting portion 23.

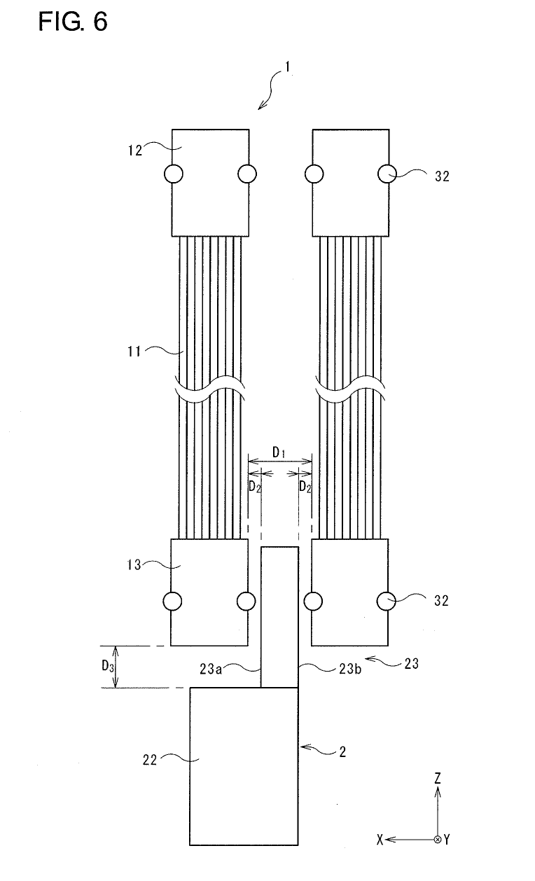

As illustrated in FIG. 6, the top end of the base portion 22 of the air bubble generation module 2 is disposed below the bottom ends of a pair of adjacent lower holding members 13. In addition, the base portion 22 of the air bubble generation module 2 partially overlaps a lower holding member 13 in plan view. Also, the projecting portion 23 of the air bubble generation module 2 is disposed between the pair of adjacent lower holding members 13 in plan view. The front wall 23a and the rear wall 23b of the projecting portion 23 of the air bubble generation module 2 oppose side surfaces of the pair of adjacent lower holding members 13 in a horizontal direction.

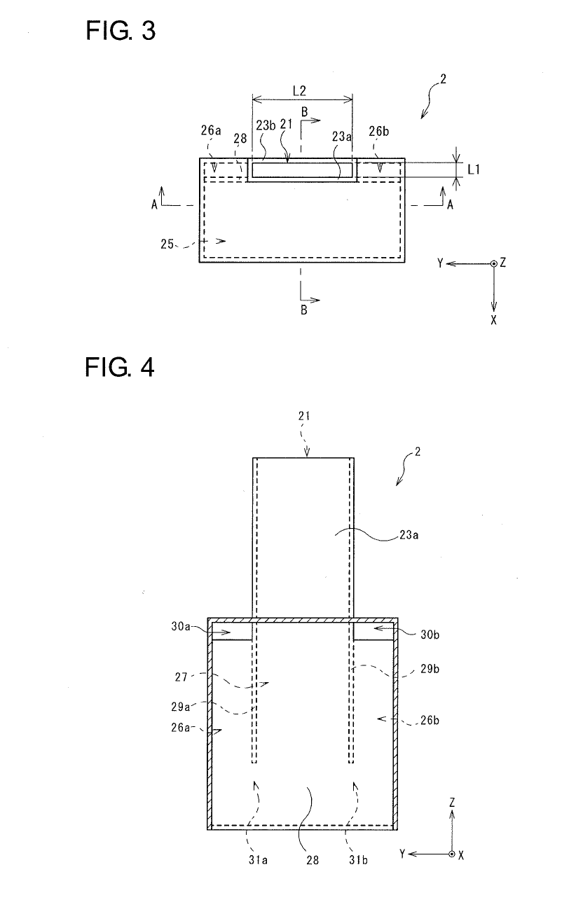

As illustrated in FIG. 3, the discharge port 21 of the air bubble generation module 2 is preferably formed in an oblong shape whose longitudinal direction is a direction parallel to the filtration modules 1 (Y direction). When the discharge port 21 of each air bubble generation module 2 of the filter unit is formed in an oblong shape whose longitudinal direction is a direction parallel to the filtration modules 1, the diameter of the bubbles can be increased relative to the gap D₁ between the pair of adjacent lower holding members 13. As a result, the surfaces of the hollow fiber membranes 11 can be more efficiently cleaned.

Although the discharge port 21 of each air bubble generation module 2 is preferably formed in an oblong shape whose longitudinal direction is a direction parallel to the filtration modules 1 (Y direction), the configuration of each air bubble generation module 2 is not limited to this. According to the filter unit, even when the discharge port 21 does not have the above-described oblong shape, the bubbles discharged from the discharge port 21 can be prevented from coming into contact with the bottom surfaces of the lower holding members 13, and the cleaning effect can thus be enhanced.

The lower limit of the gap D₁ between the pair of adjacent lower holding members 13 is preferably 15 mm, and more preferably 18 mm. The upper limit of the gap D₁ between the pair of adjacent lower holding members 13 is preferably 30 mm, and more preferably 25 mm. When the gap D₁ between the pair of adjacent lower holding members 13 is below the lower limit, sufficiently large bubbles cannot be discharged from the air bubble generation module 2, and there is a risk that sufficient cleaning effect cannot be provided by the bubbles discharged from the discharge port 21 of the air bubble generation module 2. When the gap D₁ between the pair of adjacent lower holding members 13 is above the upper limit, the discharge port 21 of the air bubble generation module 2 is spaced from the hollow fiber membranes 11 by a large distance in a horizontal direction, and there is a risk that sufficient cleaning effect cannot be provided by the bubbles discharged from the discharge port 21 of the air bubble generation module 2. Also, when the gap D₁ between the pair of adjacent lower holding members 13 is above the upper limit, there is a risk that the filter unit will be unnecessarily large.

The lower limit of the length L1 of the discharge port 21 in the transverse direction is preferably 5 mm, and more preferably 7 mm. The upper limit of the length L1 of the discharge port 21 in the transverse direction is preferably 20 mm, and more preferably 13 mm. When the length L1 of the discharge port 21 in the transverse direction is below the lower limit, sufficiently large bubbles cannot be discharged, and there is a risk that the surfaces of the hollow fiber membranes 11 cannot be appropriately abraded by the bubbles discharged from the discharge port 21 of the air bubble generation module 2. When the length L1 of the discharge port 21 in the transverse direction is above the upper limit, individual bubbles will be too large and the number of bubbles discharged from the discharge port 21 will be reduced. Accordingly, there is a risk that the cleaning efficiency will be insufficient. In addition, when the length L1 of the discharge port 21 in the transverse direction is above the upper limit, there is a risk that the bubbles will break and the surfaces of the hollow fiber membranes 11 cannot be appropriately abraded by the bubbles discharged from the discharge port 21.

The lower limit of the length L2 of the discharge port 21 in the longitudinal direction is preferably 20 mm, more preferably 30 mm, and still more preferably 35 mm. The upper limit of the length L2 of the discharge port 21 in the longitudinal direction is preferably 80 mm, more preferably 70 mm, and still more preferably 65 mm. When the length L2 of the discharge port 21 in the longitudinal direction is below the lower limit, sufficiently large bubbles cannot be discharged, and there is a risk that the surfaces of the hollow fiber membranes 11 cannot be appropriately abraded by the bubbles discharged from the discharge port 21 of the air bubble generation module 2. When the length L2 of the discharge port 21 in the longitudinal direction is above the upper limit, individual bubbles will be too large and the number of bubbles discharged from the discharge port 21 will be reduced. Accordingly, there is a risk that the cleaning efficiency will be insufficient. In addition, when the length L2 of the discharge port 21 in the longitudinal direction is above the upper limit, there is a risk that the bubbles will break and the surfaces of the hollow fiber membranes 11 cannot be appropriately abraded by the bubbles discharged from the discharge port 21.

The lower limit of the area S of the discharge port 21 is preferably 100 mm², more preferably 200 mm², and still more preferably 300 mm². The upper limit of the area S of the discharge port 21 is preferably 1000 mm², more preferably 800 mm², and still more preferably 600 mm². When the area S of the discharge port 21 is below the lower limit, sufficiently large bubbles cannot be discharged, and there is a risk that the surfaces of the hollow fiber membranes 11 cannot be appropriately abraded by the bubbles discharged from the discharge port 21 of the air bubble generation module 2. When the area S of the discharge port 21 is above the upper limit, individual bubbles will be too large and the number of bubbles discharged from the discharge port 21 will be reduced. Accordingly, there is a risk that the cleaning efficiency will be insufficient. In addition, when the area S of the discharge port 21 is above the upper limit, there is a risk that the bubbles will break and the surfaces of the hollow fiber membranes 11 cannot be appropriately abraded by the bubbles discharged from the discharge port 21.

The lower limit of the ratio (S/D₁) of the area S of the discharge port 21 to the gap D₁ between the pair of adjacent lower holding members 13 is preferably 6, more preferably 10, and still more preferably 15. The upper limit of the ratio (S/D₁) is preferably 50, more preferably 40, and still more preferably 30. When the ratio (S/D₁) is below the lower limit, the diameter of the bubbles discharged from the discharge port 21 will be too small relative to the gap D₁ between the pair of adjacent lower holding members 13, and there is a risk that the surfaces of the hollow fiber membranes 11 cannot be appropriately abraded by the bubbles discharged from the discharge port 21 of the air bubble generation module 2. When the ratio (S/D₁) is above the upper limit, individual bubbles will be too large and the number of bubbles discharged from the discharge port 21 will be reduced. Accordingly, there is a risk that the cleaning efficiency will be insufficient. In addition, when the ratio (S/D₁) is above the upper limit, there is a risk that the bubbles will break and the surfaces of the hollow fiber membranes 11 cannot be appropriately abraded by the bubbles discharged from the discharge port 21.

The discharge port 21 of the air bubble generation module 2 is preferably at a horizontal level close to a horizontal level of the top ends of the lower holding members 13 of the pair of adjacent filtration modules 1. When the discharge port 21 of each air bubble generation module 2 of the filter unit is at a horizontal level close to the horizontal level of the top ends of the lower holding members 13 of the pair of adjacent filtration modules 1, the bubbles discharged from the discharge port 21 can be supplied to the hollow fiber membranes 11 without causing the bubbles to come into contact with the side surfaces of the lower holding members 13. Therefore, portions of the hollow fiber membranes 11 around the bottom ends of the hollow fiber membranes 11 can be easily cleaned. In addition, when the filter unit is configured as described above, the distance over which the surfaces of the hollow fiber membranes 11 are abraded by the bubbles discharged from the discharge port 21 can be increased. Accordingly, the cleaning effect provided by the bubbles can be further enhanced.

In the case where the discharge port 21 of the air bubble generation module 2 is at a horizontal level close to the horizontal level of the top ends of the lower holding members 13 of the pair of adjacent filtration modules 1, the horizontal level of the discharge port 21 of the gas generation module 2 is preferably below the top ends of the lower holding members 13 of the pair of adjacent filtration modules 1. When the horizontal level of the discharge port 21 of each gas generation module 2 of the filter unit is below the top ends of the lower holding members 13 of the pair of adjacent filtration modules 1, the cleaning effect on the bottom end portions of the hollow fiber membranes 11 of the pair of adjacent filtration modules 1 can be easily increased.

Although the discharge port 21 of the air bubble generation module 2 is preferably at a horizontal level close to the horizontal level of the top ends of the lower holding members 13 of the pair of adjacent filtration modules 1 as described above, the configuration of the air bubble generation module 2 is not limited to this. Also when, for example, the discharge port 21 of each air bubble generation module 2 of the filter unit is at a horizontal level close to a horizontal level of the bottom ends of the lower holding members 13 of the pair of adjacent filtration modules 1, the bubbles can be prevented from coming into contact with the bottom surfaces of the lower holding members 13, and the cleaning effect can thus be increased.

The air bubble generation module 2 preferably has gaps between itself and the side surfaces of the lower holding members 13 of the pair of adjacent filtration modules 1. More specifically, the air bubble generation module 2 preferably has gaps between itself and the lower holding members 13 of the pair of adjacent filtration modules 1 in regions between the top and bottom ends of the lower holding members 13. When each air bubble generation module 2 of the filter unit has gaps between the air bubble generation module 2 and the side surfaces of the lower holding members 13 of the pair of adjacent filtration modules 1, the upward pressure applied to the bubbles discharged from the discharge port 21 can be increased by using the upward flow of the untreated liquid that is present between the air bubble generation module 2 and the side surfaces of the lower holding members 13 of the pair of adjacent filtration modules 1. Accordingly, in the filter unit, the cleaning effect provided by the bubbles discharged from the discharge port 21 can be further enhanced. Here, the state in which “each air bubble generation module has gaps between the air bubble generation module and side surfaces of the lower holding members of the pair of adjacent filtration modules” is not limited to the case where the bubble generation module is completely (entirely) spaced from the side surfaces of the pair of adjacent lower holding members, and includes the case where the air bubble generation module is partially in contact with the side surfaces of the pair of adjacent lower holding members. To enhance the cleaning effect, the air bubble generation module is preferably completely (entirely) spaced from the side surfaces of the pair of adjacent lower holding members.

The lower limit of the average gap D₂ between the air bubble generation module 2 and the side surfaces of the lower holding members 13 of the adjacent filtration modules 1 is preferably 1 mm, and more preferably 1.5 mm. The upper limit of the average gap D₂ is preferably 4 mm, and more preferably 3 mm. When the average gap D₂ is below the lower limit, there is a risk that the amount of upward flow of the untreated liquid will be insufficient. When the average gap D₂ is above the upper limit, the discharge port 21 of the air bubble generation module 2 is spaced from the hollow fiber membranes 11 by a large distance in a horizontal direction, and there is a risk that sufficient cleaning effect cannot be provided by the bubbles discharged from the discharge port 21 of the air bubble generation module 2. In this specification, the term “average gap” is the average of the gaps at any 10 positions.

In the case where the air bubble generation module 2 has gaps between itself and the side surfaces of the lower holding members 13 of the pair of adjacent filtration modules 1, preferably, the air bubble generation module 2 also has gaps between itself and the bottom surfaces of the lower holding members 13 of the pair of adjacent filtration modules 1. More specifically, the air bubble generation module 2 is preferably arranged so that a gap is provided between the top surface of the base portion 22 of the air bubble generation module 2 and the bottom surface of the lower holding member 13 disposed above the base portion 22. When each air bubble generation module 2 of the filter unit has gaps not only between the air bubble generation module 2 and the side surfaces of the lower holding members 13 of the pair of adjacent filtration modules 1 but also between the air bubble generation module 2 and the bottom surfaces of the lower holding members 13, the cleaning effect can be further enhanced by using the upward flow of the untreated liquid that is present between the air bubble generation module 2 and the lower holding members 13. Here, the state in which “each air bubble generation module has gaps between the air bubble generation module and the bottom surfaces of the lower holding members of the pair of adjacent filtration modules” is not limited to the case where the base portion of the air bubble generation module is completely (entirely) spaced from the lower holding member, and includes the case where the base portion of the air bubble generation module is partially in contact with the bottom surface of the lower holding member.

In particular, the air bubble generation module 2 is preferably spaced from the lower holding members 13 of the pair of adjacent filtration modules 1. In other words, the air bubble generation module 2 is preferably completely spaced from the side surfaces of the lower holding members 13 of the pair of adjacent filtration modules 1 and from the bottom surfaces of the lower holding members 13 of the pair of adjacent filtration modules 1. When each air bubble generation module 2 of the filter unit is spaced from the lower holding members 13 of the pair of adjacent filtration modules 1, the upward flow of the untreated liquid can be easily generated between the air bubble generation module 2 and the lower holding members 13 of the pair of adjacent filtration modules 1. Accordingly, in the filter unit, the upward pressure applied to the bubbles discharged from the discharge port 21 can be easily and reliably increased by using the upward flow of the untreated liquid, and the cleaning effect can be further enhanced.

The average gap D₃ between the air bubble generation module 2 and the bottom surfaces of the lower holding members 13 of the adjacent filtration modules 1 is preferably greater than the average gap D₂ between the air bubble generation module 2 and the side surfaces of the lower holding members 13 of the adjacent filtration modules 1. In the filter unit, the average gap D₃ between each air bubble generation module 2 and the bottom surfaces of the lower holding members 13 of the adjacent filtration modules 1 is greater than the average gap D₂ between the air bubble generation module 2 and the side surfaces of the lower holding members 13 of the adjacent filtration modules 1. Therefore, the upward flow of the untreated liquid that passes through the gaps between each air bubble generation module 2 and the bottom surfaces of the lower holding members 13 and through the gaps between the air bubble generation module 2 and the side surface of the lower holding members 13 can be easily generated.

The lower limit of the average gap D₃ between the air bubble generation module 2 and the bottom surfaces of the lower holding members 13 of the adjacent filtration modules 1 is preferably 6 mm, and more preferably 8 mm. The upper limit of the average gap D₃ is preferably 30 mm, and more preferably 15 mm. When the average gap D₃ is below the lower limit, there is a risk that it will be difficult to generate a sufficient amount of upward flow of the untreated liquid. When the average gap D₃ is above the upper limit, there is a risk that the filter unit will be unnecessarily large.

The air bubble generation modules 2 of the filter unit extend continuously in a direction parallel to the filtration modules 1 (Y direction). The diffuser tubes 4 of the filter unit are arranged so as to overlap the openings 24 in the air bubble generation modules 2 in plan view. When the filter unit has such a configuration, the gas discharged from the diffuser tubes 4 can be easily and reliably introduced into the gas introducing chambers 25 of the air bubble generation modules 2. In addition, in the filter unit, the bubbles can be easily and reliably supplied to the surfaces of all of the hollow fiber membranes 11 included in the pair of adjacent filtration modules 1 by discharging the bubbles from the discharge ports 21 of the air bubble generation modules 2 that extend continuously.

### (Diffuser Tubes)

The diffuser tubes 4 include straight tube portions whose axes extend in a direction parallel to the filtration modules 1 (Y direction). The straight tube portions are disposed beneath the air bubble generation modules 2. The diffuser tubes 4 each have a plurality of diffusion holes arranged in the axial direction of the straight tube portions. The diffusion holes are disposed beneath the openings 24 of the air bubble generation modules 2. The diffuser tubes 4 are configured so that gas is introduced into each diffuser tube 4 from one end thereof and discharged through the diffusion holes and that the discharged gas can be introduced into the gas introducing chambers 25 of the air bubble generation modules 2 through the openings 24.

### (Hollow Fiber Membranes)

The hollow fiber membranes 11 are tubes formed of porous membranes that allow liquid to permeate therethrough and prevent impurities contained in the untreated liquid from permeating therethrough.

The hollow fiber membranes 11 may contain a thermoplastic resin as a main component thereof. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). Among these, PTFE, which is excellent in terms of mechanical strength, chemical resistance, heat resistance, weather resistance, flame resistance, etc., and which is porous, is preferable, and uniaxially or biaxially expanded PTFE is more preferable. The material of the hollow fiber membranes 11 may contain, for example, other polymers and additives such as a lubricant as appropriate.

The lower limit of the average length of the bundles of the hollow fiber membranes 11 in the longitudinal direction thereof in a cross section perpendicular to the up-down direction (average length in the Y direction) is preferably 300 mm, and more preferably 500 mm. The upper limit of the average length of the bundles of the hollow fiber membranes 11 in the long-axis direction thereof is preferably 1200 mm, and more preferably 1000 mm. When the average length of the bundles of the hollow fiber membranes 11 in the long-axis direction thereof is below the lower limit, there is a risk that the filtration efficiency will be insufficient. When the average length of the bundles of the hollow fiber membranes 11 in the long-axis direction thereof is above the upper limit, there is a risk that handling of the filtration modules 1 will be difficult.

The lower limit of the average length of the bundles of the hollow fiber membranes 11 in a direction perpendicular to the long axis thereof (transverse direction) in a cross section perpendicular to the up-down direction (average length in the X direction) is preferably 10 mm, and more preferably 15 mm. The upper limit of the average length of the bundles of the hollow fiber membranes 11 in the direction perpendicular to the long axis is preferably 100 mm, and more preferably 75 mm. When the average length of the bundles of the hollow fiber membranes 11 in the direction perpendicular to the long axis is below the lower limit, there is a risk that sufficient filtration efficiency cannot be obtained. When the average length of the bundles of the hollow fiber membranes 11 in the direction perpendicular to the long axis is above the upper limit, there is a risk that the bubbles discharged from the discharge ports 21 of the air bubble generation modules 2 cannot be appropriately supplied to the central portions of the bundles of the hollow fiber membranes 11.

The lower limit of the average effective length of the hollow fiber membranes 11 (average length of the hollow fiber membranes 11 between the bottom ends of the upper holding members 12 and the top ends of the lower holding members 13) is preferably 1 m, and more preferably 2 m. The upper limit of the average effective length of the hollow fiber membranes 11 is preferably 6 m, and more preferably 5 m. When the average effective length of the hollow fiber membranes 11 is below the lower limit, there is a risk that the titubation of the hollow fiber membranes 11 caused by the abrasion by the bubbles will be insufficient, and the gaps between the hollow fiber membranes 11 cannot be increased enough to guide the gas therethrough. When the average effective length of the hollow fiber membranes 11 is above the upper limit, there is a risk that the fiber membranes 11 will be excessively bent due to the weight thereof and that the filtration modules 1 cannot be easily handled when, for example, the filtration modules 1 are attached or removed.

### (Upper Holding Members)

Each upper holding member 12 has an internal space that communicates with hollow portions of the hollow-fiber membranes 11 held by the upper holding member 12, and is provided with a drain nozzle 12a that discharges the treated liquid that has been filtered by the hollow-fiber membranes 11 from the internal space. Each upper holding member 12 has a rectangular parallelepiped shape having a longitudinal direction in the long-axis direction of the bundle of the hollow fiber membranes 11 (Y direction), a transverse direction in a direction perpendicular to the long axis of the bundle of the hollow fiber membranes 11 (X direction), and a height direction in the up-down direction (Z direction).

### (Lower Holding Members)

Each lower holding member 13 may either have an internal space similar to that of each upper holding member 12 or hold the bottom ends of the hollow fiber membranes 11 so as to block the openings in the hollow fiber membranes 11. The front wall 23a and the rear wall 23b of the projecting portion 23 of each air bubble generation module 2 oppose a pair of side surfaces of the lower holding members 13. Each lower holding member 13 has a rectangular parallelepiped shape having a longitudinal direction in the long-axis direction of the bundle of the hollow fiber membranes 11 (Y direction), a transverse direction in a direction perpendicular to the long axis of the bundle of the hollow fiber membranes 11 (X direction), and a height direction in the up-down direction (Z direction).

The lower limit of the ratio of the average length of the lower holding members 13 in the transverse direction (average length in the X direction) to the average length of the bundles of the hollow fiber membranes 11 in the direction perpendicular to the long axis (average length in the X direction) is preferably 1.05, and more preferably 1.1. The upper limit of the ratio is preferably 1.3, and more preferably 1.2. When the ratio is below the lower limit, there is a risk that the bottom ends of the hollow fiber membranes 11 cannot be appropriately fixed to the lower holding members 13. When the ratio is above the upper limit, there is a risk that the bubbles discharged from the discharge ports 21 of the air bubble generation modules 2 cannot be appropriately supplied to the hollow fiber membranes 11. The ratio of the average length of the upper holding members 12 in the transverse direction (average length in the X direction) to the average length of the bundles of the hollow fiber membranes 11 in the direction perpendicular to the long axis (average length in the X direction) may be equivalent to the ratio of the average length of the lower holding members 13 in the transverse direction to the average length of the bundles of the hollow fiber membranes 11 in the direction perpendicular to the long axis.

### (Frame)

The frame 3 includes a plurality of round bars 32 that retain the side surfaces of the upper holding members 12 and the lower holding members 13 of the filtration modules 1. The frame 3 holds the filtration modules 1 by retaining the side surfaces of the upper holding members 12 and the lower holding members 13 of the filtration modules 1 with the round bars 32. The frame 3 also holds the air bubble generation modules 2. The method by which the frame 3 holds the air bubble generation modules 2 is not particularly limited. For example, the frame 3 may hold each of the air bubble generation modules 2 that extend continuously in the direction parallel to the filtration modules 1 (Y direction), or collectively hold the air bubble generation modules 2 that are connected and fixed together.

### (Discharge Mechanism)

The discharge mechanism 5 is connected to the drain nozzles 12a of the filtration modules 1, and includes a collecting pipe 51 that collects the treated liquid that has been filtered and a suction pump 52 that sucks the treated liquid from the collecting pipe 51.

### OTHER EMBODIMENTS

It is to be understood that the embodiment disclosed herein is an example and not restrictive in all respects. The scope of the present invention is not limited by the configuration of the above-described embodiment but is defined by the claims, and is intended to include equivalents to the scope of the claims and all modifications within the scope of the claims.

For example, the air bubble generation modules are not necessarily continuous in the direction parallel to the filtration modules (Y direction). The air bubble generation modules may instead be arranged at certain intervals in the direction parallel to the filtration modules.

The diffuser tubes are not necessarily disposed beneath the openings in the air bubble generation modules. For example, the diffuser tubes may instead be provided so as to extend through the gas introducing chambers of the air bubble generation modules.

The configurations of the upper holding members, the lower holding members, the hollow fiber membranes, the frame, the discharge mechanism, etc., of the filter unit are not limited to those described in the embodiment, and various configurations may be used.

The filter unit may be used as various types of filter devices such as an external pressure type filter device in which the pressure is increased at the outer peripheral surfaces of the hollow fiber membranes so that the untreated liquid permeates toward the inner peripheral surfaces of the hollow fiber membranes, an immersion type filter device in which the untreated liquid is caused to permeate toward the inner peripheral surfaces by an osmotic pressure or a negative pressure at the inner peripheral surfaces, and an internal pressure type filter device in which the pressure is increased at the inner peripheral surfaces of the hollow fiber membranes so that the untreated liquid permeates toward the outer peripheral surfaces of the hollow fiber membranes. In particular, the filter unit is suitable for use as an external pressure type filter device.

1. A filter unit comprising:
a plurality of filtration modules which each include a plurality of hollow fiber membranes extending in an up-down direction and arranged side by side in a curtain shape and a pair of holding members to which top and bottom ends of the hollow fiber membranes are fixed; and
a plurality of air bubble generation modules that discharge bubbles toward the hollow fiber membranes,
wherein the filtration modules are arranged in parallel at intervals, and
wherein each air bubble generation module has a discharge port that is disposed between lower holding members of a pair of adjacent filtration modules and above bottom ends of the lower holding members.

2. The filter unit according to claim 1, wherein the discharge port of each air bubble generation module is at a horizontal level close to a horizontal level of top ends of the lower holding members of the pair of adjacent filtration modules.

3. The filter unit according to claim 1, wherein the discharge port of each air bubble generation module is formed in an oblong shape whose longitudinal direction is a direction parallel to the filtration modules.

4. The filter unit according to claim 1, 2, or 3, wherein each air bubble generation module is configured to discharge the bubbles intermittently.

5. The filter unit according to claim 1, wherein each air bubble generation module has gaps between the air bubble generation module and side surfaces of the lower holding members of the pair of adjacent filtration modules.

6. The filter unit according to claim 5, wherein each air bubble generation module is spaced from the lower holding members of the pair of adjacent filtration modules.
